(19) United States
(12) Patent Application Publication
(10) Pub. No.: US 2005/0251965 A1
(43) Pub. Date: Nov. 17, 2005

(54) Multi-directional hinge for a notebook computer

(75) Inventors: Sheng-Nan Lu, Shulin City (TW); Te-Yang Liu, Shulin City (TW)

Correspondence Address: Jackson Walker L.L.P., Suite 2100, 112 E. Pecan Street, San Antonio, TX, 78205, US

(73) Assignee: Shin Zu Shing Co., Ltd.

(21) Appl. No.: 10/842,771

(22) Filed: May 11, 2004

(51) Int. Cl. E05D 3/10

(52) U.S. Cl. 16/367

(57) ABSTRACT

A multi-directional hinge for a notebook computer has a seat with a pintle. A base is rotatably mounted on the seat and has a hollow flange formed at a central portion of the base for receiving the pintle. Multiple rotating washers are provided outside the pintle and received in the base. A first positioning washer is provided outside the pintle and abuts the rotating washers. A bottom cover is provided under the rotating washers and fastened at a bottom end of the pintle. Whereby, a horizontal view angle of an LCD monitor of the notebook computer can be adjusted, and the LCD monitor can be positioned at the desired viewing angle and will not freely leave this position if unintentionally touched.

### BACKGROUND OF THE INVENTION

1. Field of the Invention

The present invention relates to a hinge for a notebook computer, and more particularly to a hinge which can rotate about a horizontal axis and a vertical axis.

2. Description of Related Art

For turning an LCD monitor left or right in a raised status, a notebook computer is provided with a multi-directional hinge between the LCD monitor and a body of the notebook computer. However, the conventional hinge does not have designs for retaining the LCD monitor at a desired angle, so the LCD monitor may leave this position if someone touches it carelessly: Furthermore, because most elements of the conventional hinge are made of Zinc alloy with a low hardness and there is no antifriction component fitted between the elements being rotated relative to each other, these elements will soon experience significant wear.

Therefore, the invention provides a multi-directional hinge to mitigate or obviate the aforementioned problems.

### SUMMARY OF THE INVENTION

The main objective of the present invention is to provide a multi-directional hinge with which a horizontal view angle of an LCD monitor in a raised status can be adjusted and the LCD monitor can be retained at some special angles.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a multi-directional hinge for a notebook computer in accordance with the present invention;

FIG. 2 is an exploded bottom perspective view of the multi-directional hinge for a notebook computer in FIG. 1;

FIG. 3 is an exploded top perspective view of the multi-directional hinge for a notebook computer in FIG. 1;

FIG. 4 is a side sectional view of the multi-directional hinge in FIG. 1;

FIG. 5 is a top view of the multi-directional hinge assembled in a notebook computer;

FIG. 6 is a perspective view of the notebook computer assembled with the multi-directional hinge;

FIG. 7 is a perspective view of the notebook computer being rotated relative to a vertical axis; and

FIG. 8 is a partial view of the hinge shown in FIG. 7.

### DETAILED DESCRIPTION OF THE PREFERRED EMBODIMENT

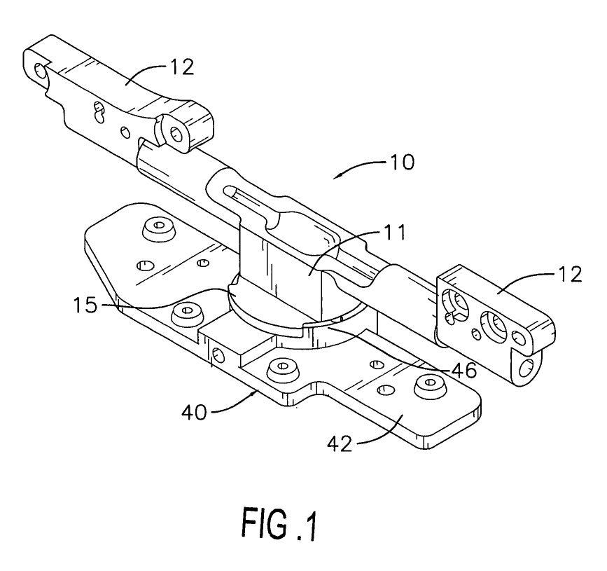

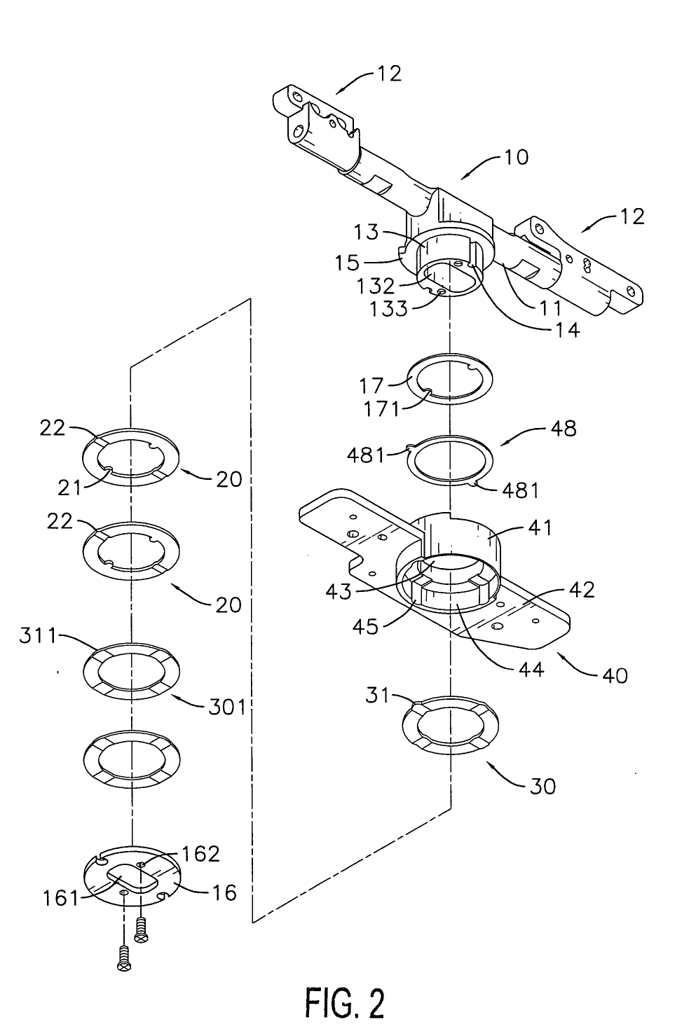

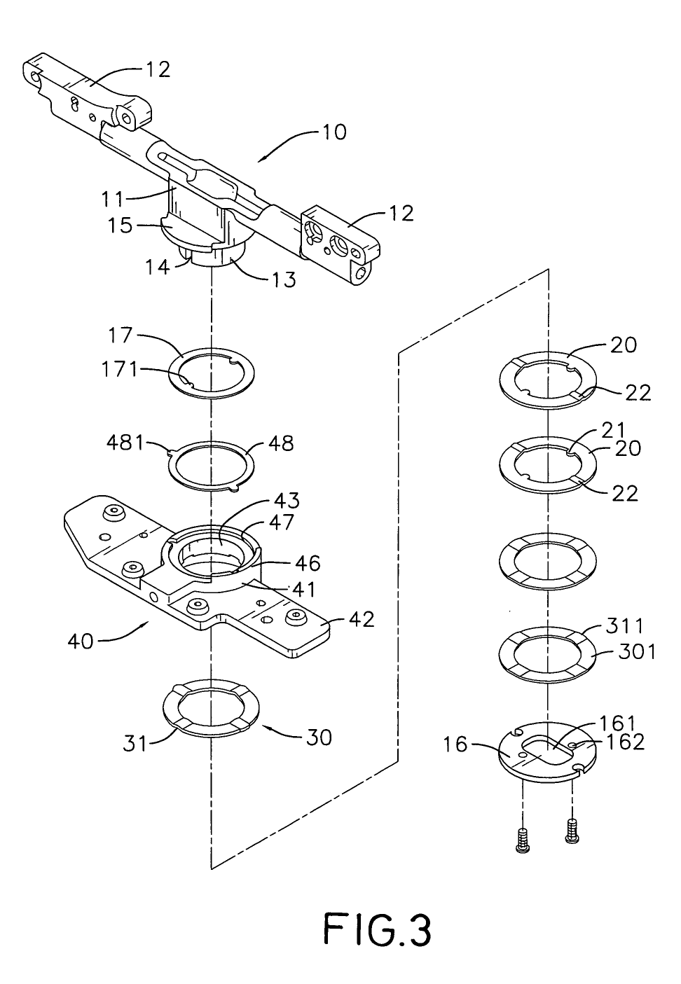

With reference to FIGS. 1-3, a multi-directional hinge for a notebook computer is composed of a base (40), a seat (10) rotatably mounted on the base (40), and multiple washers (20, 30, 301) in the seat (10) and the base (40).

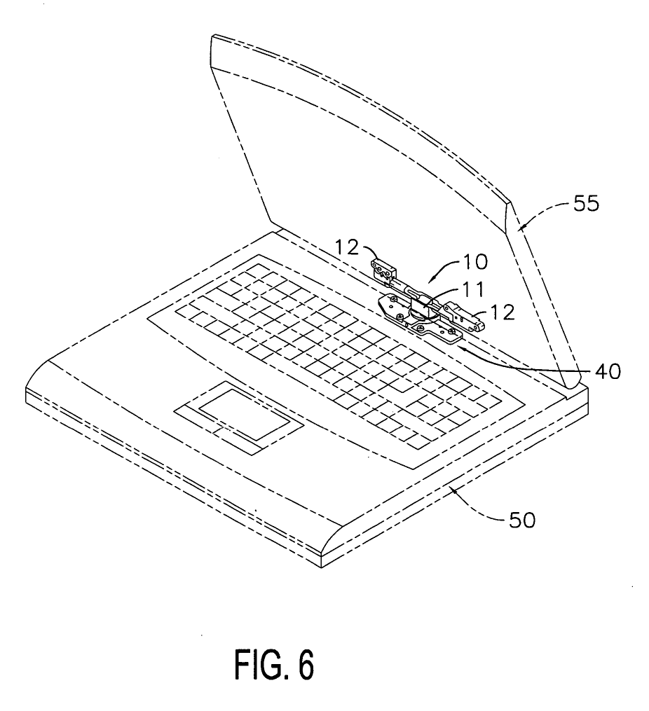

With reference to FIGS. 1, 2, 3 and 6, the seat (10) has an axle (11) with two ends. Two pivoting members (12) are respectively and pivotally mounted on the two ends of the axle (11). An LCD monitor (55) of a notebook computer is fastened on the two pivoting members (12). A pintle (13) extends downwards from a central portion of the axle (11). A first wire hole (132) is defined through the pintle (13) and two threaded holes (133) are defined at respective sides of the wire hole (132). Two elongated recesses (14) are defined at an outer periphery of the pintle (13). An arcuate tongue (15) is formed between the axle (11) and the pintle (13). An antifriction ring (17) is provided outside the pintle (13) and has two first lugs (171) formed at an inner circumference thereof and respectively positioned in the recesses (14).

At least two of the rotating washers (20) are provided outside the pintle (13), and each have two second lugs (21) formed at an inner circumference thereof and respectively positioned in the recesses (14). Two first protrusions (22) are formed at a top surface of each of the rotating washers (20), and two first depressions (not numbered) corresponding to the first protrusions (22) are defined at a bottom surface of each of the rotating washers (20).

A first positioning washer (30) is provided outside the pintle (13) and between the antifriction ring (17) and the rotating washers (20). The first positioning washer (30) has four second protrusions (31) evenly formed at a top surface thereof, and four second depressions (not numbered) corresponding to the second protrusions (31) defined at a bottom surface thereof for receiving the first protrusions (22) of the upper rotating washer (20).

At least one second positioning washer (301) is provided under the rotating washers (20), and has multiple third protrusions (311) evenly formed at a top surface thereof for being positioned in the first depressions of the rotating washer (20). The third protrusions (311) have a smaller height than the second protrusions (31), so the third depressions have a smaller depth than the third depressions.

The base (40) has a hollow flange (41) formed at a central portion thereof. Two wings (42) are formed at two diametrically opposite sides of the hollow flange (41), by which the base (40) is fastened on a body (50) of the notebook computer. A passage (43) is defined through the hollow flange (41) for receiving the pintle (13) therein, and a chamber (44) with a larger diameter than that of the passage (43) is defined beneath the passage (43) for receiving the positioning washers (30, 31) and the rotating washers (20). Multiple grooves (45) are evenly defined in an inner wall of the chamber (44), and the second protrusions (31) and third protrusions (311) are respectively positioned in the grooves (45), so the first and second positioning washers (30, 301) cannot rotate in the chamber (44).

A stop (46) is formed at a top surface of the flange (41) for limiting a rotating range of the seat (10) when the arcuate tongue (15) is blocked by the stop (46). A counterbore (47) with two notches (not numbered) is defined at the top surface of the flange (41). A washer (48), with two bosses (481) formed at an outer circumference of the washer (48), is located in the counterbore (47) and abuts the antifriction ring (17). The antifriction ring (17) and the washer (48) ensure that the direct friction between the seat (10) and the base (40) is eliminated.

A bottom cover (16) is provided under the second positioning washers (301) and has a second wire hole (161) defined through the bottom cover (16) and corresponding to the first wire hole (132). Two holes (162) are defined beside the second wire hole (161) and aligned with the threaded holes (133). By screws being extended through the holes (162) and engaged in the threaded holes (133), the bottom cover is fastened on the pintle (13) to close the chamber (44).

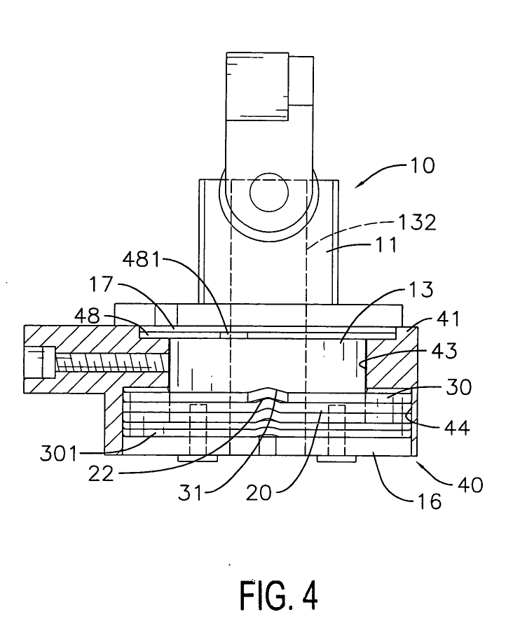

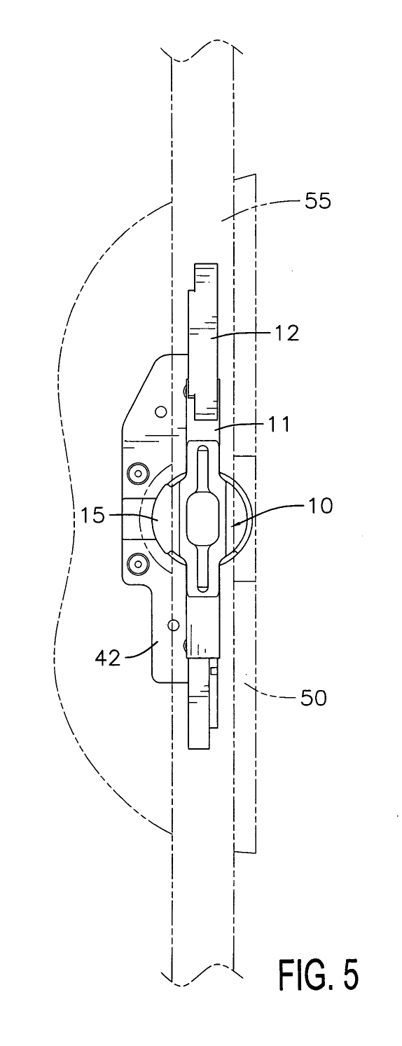

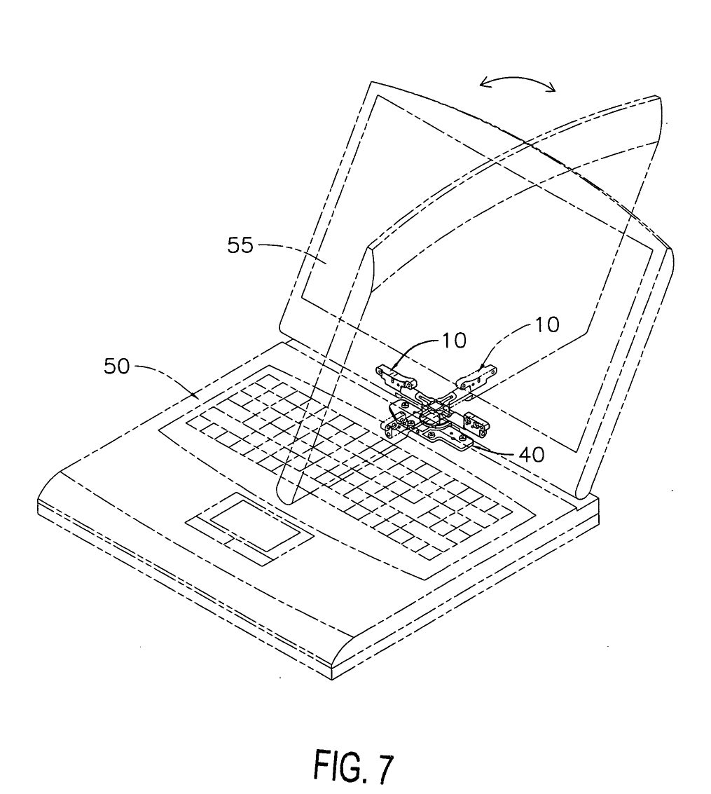

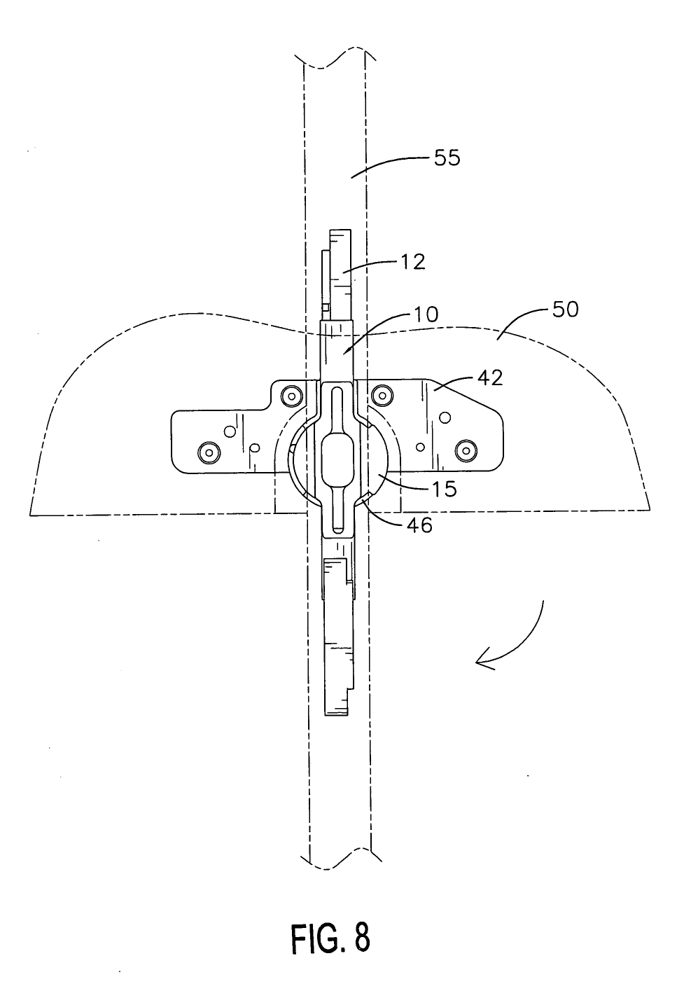

With reference to FIGS. 4-8, the seat (10) is installed on the LCD monitor (55) of the notebook computer, and the base (40) is installed on the body (50) of the notebook computer.

When the pivoting members (12) are rotated about the horizontal axle (11), the LCD monitor (55) can be raised from the body (50) or be turned downwards to abut the body (50).

The LCD monitor (55) can be turned about a vertical axis when the pintle (13) of the seat (10) is rotated about the base (40). While the rotating washers (20) are rotated along with the pintle (13) and relative to the positioning washers (30, 301), the first protrusions (22) are disengaged from the second depressions of the first positioning washer (30) under the external force. When the first protrusions (22) are received in other second depressions of the first positioning washer (30), the LCD monitor (55) can be positioned. In this embodiment, the positioning washer (30) has four second depressions, so the LCD monitor (55) can be positioned at the 90° and 180° angles relative to the original raised angle.

Therefore, by using the multiple-directional hinge according to the present invention, a horizontal view angle of the LCD monitor (55) of the notebook computer can be adjusted, and the LCD monitor (55) can be positioned at the desired viewing angle and will not freely leave this position if unintentionally touched.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A multi-directional hinge for a notebook computer comprising:
a seat (10) having an axle (11) with two ends, two pivoting members (12) pivotally mounted at the two ends of the seat (10), a pintle (13) extending downwards from a central portion of the axle (11);
a base (40) rotatably mounted the seat (10), the base (40) having a hollow flange (41) formed at a central portion of the base (40), two wings (42) formed at two diametrically opposite sides of the hollow flange (41), a passage (43) defined through the hollow flange (41) for receiving the pintle (13) in the passage (43), and a chamber (44) defined beneath the passage (43);
multiple rotating washers (20) provided outside the pintle (13) and received in the chamber (44) and being non-rotatable about the pintle (13), each rotating washer (20) having at least one first protrusion (22) formed at a top surface of the rotating washer (20) and at least one first depression corresponding to the first protrusion (22) defined at a bottom surface of the rotating washer (20);
a first positioning washer (30) provided outside the pintle (13) and above the rotating washers (20) and received in the chamber (44) and being non-rotatable about the base (40), the first positioning washer (30) having multiple second protrusions (31) formed at a top surface of the first positioning washer (30) and multiple second depressions corresponding to the second protrusions (31) defined at a bottom surface of the positioning washer (30) for being engaged with the first protrusion (22); and
a bottom cover (16) provided under the rotating washers (20) and fastened at a bottom end of the pintle (13) to close the chamber (44).

2. The multi-directional hinge as claimed in claim 1, wherein the pintle (13) has multiple enlarged recesses (14) defined at an outer periphery of the pintle (13), and an antifriction ring (17) is provided outside the pintle (13) between the seat (10) and the base (40), and has two first lugs (171) formed at an inner circumference of the antifriction ring (17) and respectively positioned in the recesses (14).

3. The multi-directional hinge as claimed in claim 2, wherein the rotating washers (20) each have two second lugs (21) formed at an inner circumference of the respective rotating washer (20) and respectively positioned in the recesses (14) of the pintle (13).

4. The multi-directional hinge as claimed in claim 1, wherein the chamber (44) has multiple grooves (45) defined at an inner wall of the chamber (44), and the first protrusions (31) are respectively positioned in the grooves (45) to disable the first positioning washer (30) from being rotatable about the base (40).

5. The multi-directional hinge as claimed in claim 1 further comprising multiple second positioning washers (301) provided under the rotating rings (20), wherein the second positioning washers (301) each have multiple third protrusions (311) formed at a top surface of the second positioning washer (301) for being engaged in the second depression of the lower rotating washer (20).

6. The multi-directional hinge as claimed in claim 5, wherein the third protrusions (311) have a smaller height than the height the second protrusions (31).

7. The multi-directional hinge as claimed in claim 2, wherein the seat (10) further has an arcuate tongue (15) formed between the axle (11) and the pintle (13), and the hollow flange (41) has a stop (46) formed at a top surface of the flange (41) for blocking the arcuate tongue (15) to limit the rotating range of the seat (10).

8. The multi-directional hinge as claimed in claim 7, wherein the hollow flange (41) has a counterbore (47) defined at the top surface of the hollow flange (41), and a washer (48) is securely received in the counterbore (47) and abuts the antifriction ring (17).

9. The multi-directional hinge as claimed in claim 8, wherein the washer (48) has two bosses (481) formed at an outer circumference of the washer (48) and positioned in two notches in the counterbore (47).
